(19) United States
(12) Patent Application Publication
(10) Pub. No.: US 2025/0355588 A1
(43) Pub. Date: Nov. 20, 2025

(54) SUPERBLOCK POOL EXPANSION FOR ENHANCED MANUFACTURING

(71) Applicant: Micron Technology, Inc., Boise, ID (US)

(72) Inventors: Giuseppe Cariello, Boise, ID (US); Sebastiano Pischedda, Novi, MI (US)

(21) Appl. No.: 19/205,803

(22) Filed: May 12, 2025

Related U.S. Application Data
(60) Provisional application No. 63/649,898, filed on May 20, 2024.

(51) Int. Cl. G06F 3/06

(52) U.S. Cl. CPC G06F 3/0644; G06F 3/0619; G06F 3/0679

(57) ABSTRACT

Methods, systems, and devices for superblock pool expansion for enhanced manufacturing are described. Techniques are presented for partitions to borrow portions of other partitions, e.g., during manufacturing stages. In some examples, different partitions (e.g., an enhanced memory partition and a normal partition) may be configured to original sizes. A portion of the enhanced memory partition may be “borrowed” by the normal partition for use during the manufacturing stage. The borrowed portion may be returned to the enhanced memory partition after the manufacturing stage to be used by the enhanced memory partition thereafter. By borrowing a portion of the enhanced memory partition, a larger portion of the normal partition may be used to store information during the manufacturing stage, leading to shorter programming times.

### CROSS REFERENCE

The present application for patent claims priority to U.S. Patent Application No. 63/649,898 by Cariello et al., entitled “SUPERBLOCK POOL EXPANSION FOR ENHANCED MANUFACTURING,” filed May 20, 2024, which is assigned to the assignee hereof, and which is expressly incorporated by reference in its entirety herein.

### TECHNICAL FIELD

The following relates to one or more systems for memory, including superblock pool expansion for enhanced manufacturing.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports superblock pool expansion for enhanced manufacturing in accordance with examples as disclosed herein.

FIG. 2 shows an example of a memory system that supports superblock pool expansion for enhanced manufacturing in accordance with examples as disclosed herein.

FIG. 3 shows an example of a memory system that supports superblock pool expansion for enhanced manufacturing in accordance with examples as disclosed herein.

FIG. 4 shows a block diagram of a memory system that supports superblock pool expansion for enhanced manufacturing in accordance with examples as disclosed herein.

FIG. 5 shows a flowchart illustrating a method or methods that support superblock pool expansion for enhanced manufacturing in accordance with examples as disclosed herein.

### DETAILED DESCRIPTION

Memory arrays are often separated into partitions, such as normal and enhanced memory (EM) partitions. Some of the normal partition may be used to store information. In some cases, the data may be temporarily stored in single-level cells, known as write boosters (e.g., to make it more resistant to errors and to speed up the process) during the manufacturing process and is later transferred to triple-level cells after the manufacturing process is complete. In some applications, a size of the EM partitions may be large so that a size of the normal partition is reduced. The normal partition may be used to store information during manufacturing processes. Preferably this information is stored in single-level cells. However, if the normal partition is too small, the manufacturing processes may be adjusted to store information in triple-level cells (or some other higher density storage) to account for the reduced size. This may lead to longer programming times and/or more errors in the data during the manufacturing stage.

To allow for more single-level cells during the manufacturing stage, the EM partition may originally be configured to be smaller and then reconfigured to be larger after the manufacturing stage. Although total partition sizes can be reconfigured after the manufacturing stage, this can lead to other problems, such as that data written in memory that is reconfigured from one partition to another partition may not be guaranteed to be preserved and may be lost e.g., in FTL structures reset.

Techniques are presented for partitions to borrow portions of other partitions, e.g., during manufacturing stages. In some examples, both EM and normal partitions may be configured to desired sizes for use. A portion of the EM partition may be “borrowed” by the normal partition for use during the manufacturing stage. The borrowed portion may be returned to the EM partition after the manufacturing stage to be used by the EM partition thereafter.

By borrowing a portion of the EM partition, a total size of the normal partition used to store information during the manufacturing stage may be increased. With the larger size, more information may be configured to be stored in single-level cells, leading to shorter programming times and reduced errors. Further, once the partition sizes are configured, they may not be changed (during or after) the manufacturing stage, alleviating the associated problems. Also, using this borrowing technique, data loss may be reduced or avoided by using garbage collections on borrowed portions of a partition after the manufacturing stage. For example, if a garbage collection is performed to reclaim a portion of the EM partition that was borrowed, the garbage collection may be configured to transfer that information to the normal partition.

In addition to applicability in memory systems as described herein, techniques for borrowing portions of partitions during manufacturing of memory devices may be generally implemented to improve the sustainability of various electronic devices and systems. As the use of electronic devices has become even more widespread, the quantity of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by allowing a larger portion of the normal partition to be used to store information during the manufacturing stage, which may improve programming times and lead to faster manufacturing of memory devices, among other benefits.

Features of the disclosure are illustrated and described in the context of systems, devices, and circuits. Features of the disclosure are further illustrated and described in the context of block diagrams and flowcharts.

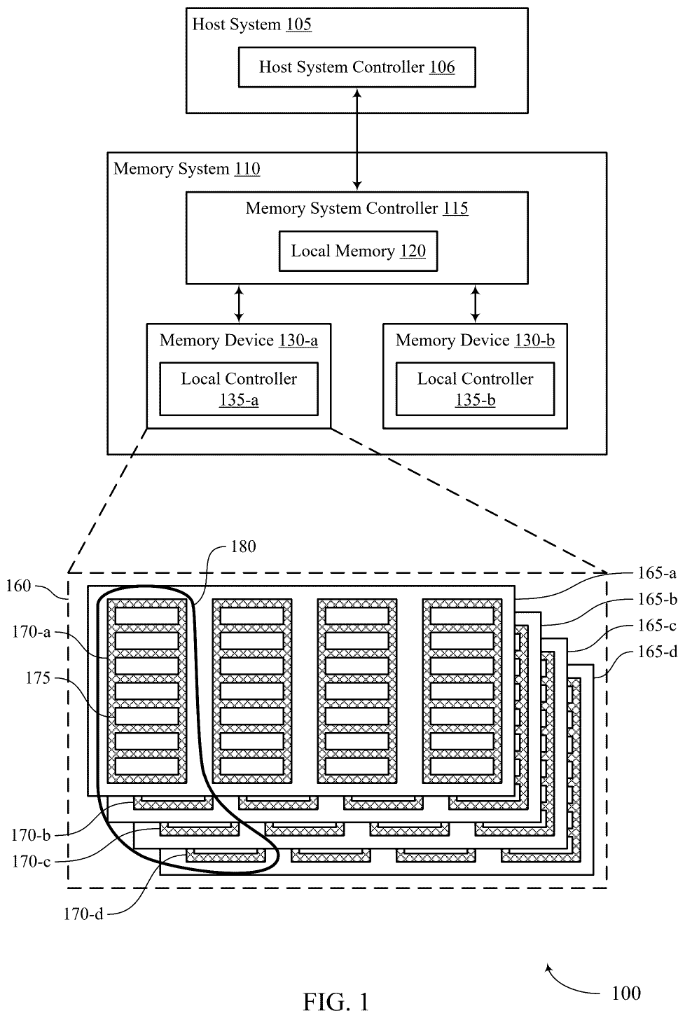

FIG. 1 shows an example of a system 100 that supports superblock pool expansion for enhanced manufacturing in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130. In some examples, the memory system controller 115 may be configured to execute or manage operations associated with partitioning of memory and borrowing of portions of partitions by other partitions, as discussed herein.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry. In some examples, a NAND memory device 130 may include memory cells that are configurable between two or more levels (e.g., between two or more of SLCs, MLCs, TLCs, QLCs, etc.).

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block. A virtual block 180, which may also be known as a superblock, may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105). In some examples, a garbage collection may be performed on a portion of a partition that is borrowed by another partition to move valid data to and release the block to its original partition, as discussed herein.

Techniques are presented for partitions to borrow portions of other partitions, e.g., during manufacturing stages. In some examples, both EM and normal partitions may be configured to desired sizes for use. A portion of the EM partition may be “borrowed” by the normal partition for use during the manufacturing stage. The borrowed portion may be returned to the EM partition after the manufacturing stage to be used by the EM partition thereafter. By borrowing a portion of the EM partition, a total size of the normal partition used to store information during the manufacturing stage may be increased. With the larger size, more information may be configured to be stored in single-level cells, leading to shorter programming times and reduced errors.

The system 100 may include any quantity of non-transitory computer readable media that support superblock pool expansion for enhanced manufacturing. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

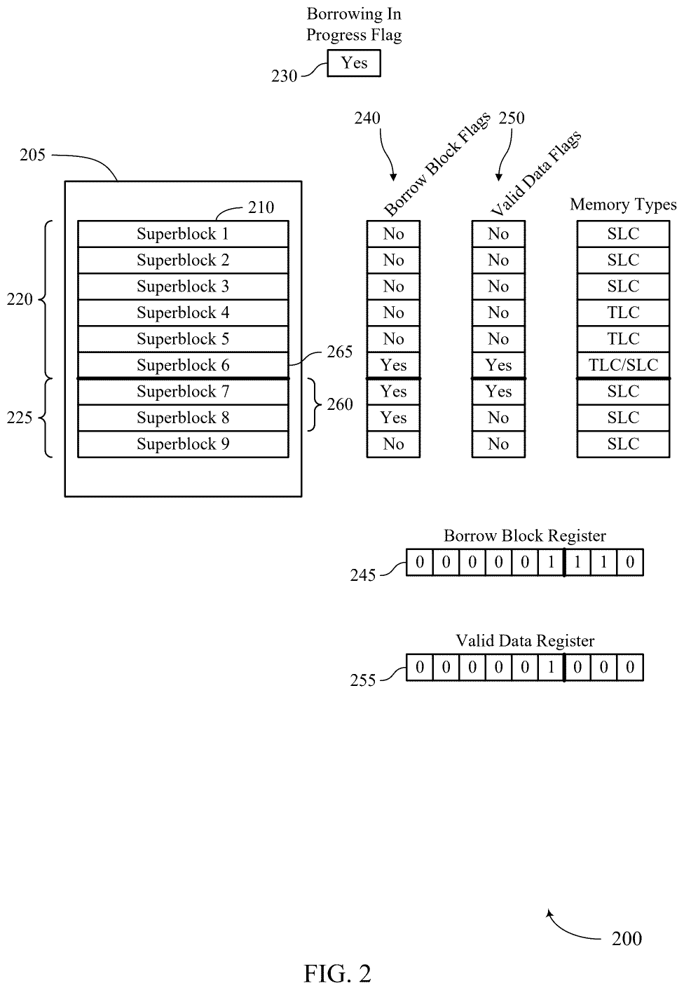

FIG. 2 shows an example of a memory system 200 that supports superblock pool expansion for enhanced manufacturing in accordance with examples as disclosed herein. The memory system 200 may be an example of a memory system 110 as described with reference to FIG. 1, or aspects thereof. The memory system 200 may include one or more arrays of memory cells (e.g., memory array 205) separated into blocks and/or superblocks 210. In some cases, superblocks may be referred to virtual blocks and vice versa. The superblocks 210 may be an example of the virtual blocks 180 as described with reference to FIG. 1.

The memory array 205 may include one or more partitions (e.g., a first partition 220 and a second partition 225) each including a different part of memory. The partitions may be separate entities or portions of the same memory. Each partition may include memory cells in one or more regions (e.g., one or more blocks 170, pages 175, or other regions of memory cells of memory system 200), each configured to store data. For example, a manufacturer may configure a product (e.g., UFS) with a first partition 220 and a second partition 225 that each include different regions (e.g., superblocks 210) of memory.

In some examples, the partitions may include different sets of operating parameters. In some examples, the partitions may have separate pools of addressing space for different usage modes. In some examples, at least one of the partitions may include some memory cells configured as SLCs and other memory cells configured as multi-level cells. For example, in the depicted example, the first partition 220 may include superblocks 1-3 having memory configured as SLCs and superblocks 4-6 having memory configured as TLCs; and the second partition 225 may include superblocks 7-9 having memory configured as SLCs. In some examples, the first partition may be configured to store information sequentially and the second partition may be configured for random access. In some examples, one partition may be a secure partition and another partition may be a non-secure partition. Other manners of dividing up the partitions are also possible.

For purposes of this application, the partitions may be used in a first operating state and a second operating state. During the first operating state, the partitions may be used in a traditional manner, without any partition borrowing any portion of another partition. As such, the first operating state may be referred to herein as the “non-borrowing state.” In the non-borrowing state, one of the partitions (e.g., first partition 220) may be used, e.g., to store applications and their static data, such as navigation applications and corresponding maps, etc. and the other partition (e.g., second partition 225) may be used, e.g., to write temporary data such as logs, black box data, or similar.

In some examples, the second memory partition 225 may use single level cells (e.g., SLCs) for quicker access and better reliability. In some examples, the first memory partition 220 may use tri-level cells (e.g., TLCs) for more dense storage of information in the same memory space. A quantity of logical addresses may be associated with the first partition 220 for reading and writing data. In some examples, a portion or all of the memory cells of a partition may be configurable between different cell types, such as between SLCs and TLCs. In some examples, one or more memory cells of a partition may be configured as SLCs and used as write boosters to buffer data for writing to TLC memory cells of the partition. The data buffering may allow for faster overall writing to the TLC memory cells, e.g., during data bursts. Reading from the logical addresses may cause data to be retrieved from the first partition 220.

During the second operating state, a portion of a partition may be selectively used (borrowed) by another partition. As such, the second operating state may be referred to herein as the “borrowing state.” The portion of a partition may include any subset of memory associated with the partition. In some examples, the portion may comprise one or more superblocks 210. In the borrowing state, the partition from which the portion is borrowed may be referred to herein as the “lending partition” and the partition that borrows the portion may be referred to herein as “the borrowing partition.” For example, if a portion of the second partition 225 is borrowed by the first partition 220, the second partition 225 may be referred to as the lending partition 225, and the first partition 220 may be referred to as the borrowing partition 220.

The selective borrowing may be accomplished by assigning a portion of the lending partition to the borrowing partition. For example, a borrowed portion 260 (e.g., superblocks 7 and 8) of the lending partition 225 may be assigned (e.g., by the controller), to the borrowing partition 220 for use by the borrowing partition during the borrowing state. For example, the borrowing partition 220 may use superblocks 7 and 8 of the second partition 225 during the borrowing state. In some examples, the memory cells of the borrowed portion 260 may be configured as SLCs and used as write boosters during the borrowing state. This may be beneficial for setting up the memory system (e.g., as part of a manufacturing process) while in the borrowed state.

The borrowed portion 260 may be returned (e.g., reassigned) back to the lending partition at the end of the borrowing state, such as after experiencing an event (e.g., based on or after completion of the manufacturing process). In some examples, the event may include an elapsing of a period of time since the manufacturing process began. In some examples, the event may include a beginning of one or more processes, or a completion of one or more processes, e.g., associated with the manufacturing process. For example, superblocks 7 and 8 may be returned to the second partition 225 when a thermal event occurs, such as applying heat to the memory system to solder components together.

In some examples, a portion (e.g., a helping portion 265) of the borrowing partition 220 may be used in conjunction with the borrowed portion 260 of the lending partition 225 during the borrowing state. The helping portion 265 may include a subset of memory associated with the borrowing partition 220. In some examples, the helping portion 265 may comprise one or more superblocks (e.g., superblock 6). In some examples, the memory cells of the helping portion 265 may be configured as different cell types in the borrowing state than in the non-borrowing state. For example, the memory cells of the helping portion 265 may be configured (e.g., by the controller) as TLCs in the non-borrowing state and SLCs in the borrowing state. Using the memory cells as SLCs during the borrowing state may allow for faster data movement into and out of those memory cells during the borrowing state while allowing the memory cells to hold more information during the non-borrowing state. In some examples, the memory cells of the helping portion 265 may be used as write boosters during the borrowing state.

Another advantage may be that, in some cases, the amount of addressable memory used by the borrowing partition 220 during the borrowing state and during the non-borrowing state may be the same. Memory configured as TLC memory cells may store three bits per memory cell, while memory configured as SLC memory cells may store 1 bit per memory cell. Thus, TLC memory cells may store three times as much data as SLC memory cells. So three SLCs may provide the same addressable memory as one TLC. Some examples of the present application leverages this difference.

The memory system may use TLC addressing techniques in the borrowing state to address a series of SLC memory cells. Such a situation may enable the addressing scheme to be the same for the borrowing partition 220, and the borrowing partition 220 may take advantage of the speed and reliability of SLC memory cells. For example, during the non-borrowing state, the borrowing partition 220 may use the helping portion 265 (e.g., superblock 6), configured as TLC memory. Then, during the borrowing state, the borrowing partition 220 may continue to use the helping portion 265 (e.g., superblock 6), but configured as SLCs. Also, during the borrowing state, the borrowing partition 220 may use the borrowed portion 260 from the lending partition 225, (e.g., superblocks 7 and 8 from the lending partition 225), which is configured as SLCs. That is, during the borrowing state, the borrowing partition may use three superblocks (e.g., superblocks 6, 7, and 8) configured as SLCs in place of one superblock (e.g., superblock 6) configured as TLCs. As a result, the borrowing partition 220 may have the same total addressable memory in the borrowing state as in the non-borrowing state. In some examples, during the borrowing state, the helping portion 265 may be linked with the borrowed portion 260. For example, superblock 6 may be linked with superblocks 7 and 8 to form three superblocks of single-level cells. In some examples, the linked superblocks may be assigned to data structure of the borrowing partition configured to track a single superblock of triple-level cells. By doing so, the storing of data to the borrowed portion may be based on assigning the linked superblocks to the data structure.

To employ three SLC superblocks in the borrowing state in place of a single TLC superblock, there may be twice as many regions associated with the borrowed portion 260 as regions associated with the helping portion 265. In some examples, the quantity of blocks or superblocks in the borrowed portion 260 of the lending partition 225 may be twice as many as are in the helping portion 265 of the borrowing partition 220. For example, the quantity of superblocks in the in the borrowed portion 260 may be 2, 4, 6, 8, and 10 when the quantity of superblocks in the helping portion 265 is 1, 2, 3, 4, and 5, respectively.

To aid in the selective borrowing, one or more flags may be used. In some examples, a first flag 230 may reflect which state the partitions are in. When set, the first flag may reflect that the partitions are in the borrowing state and when cleared, the first flag may reflect that the partitions are in the non-borrowing state. For example, when set, (e.g., by the controller), the first flag 230 may indicate that the borrowed portion 260 of the lending partition 225 is assigned to the borrowing partition 220 (i.e., being borrowed) and may indicate that the memory cell types of the helping portion 265 of the borrowing partition 220 are configured as a second cell type (e.g., SLCs). Conversely, when cleared, (e.g., by the controller), the first flag 230 may indicate that the borrowed portion 260 of the lending partition 225 is assigned to the lending partition 225 (i.e., no longer being borrowed) and may indicate that the memory cell types of the helping portion 265 of the borrowing partition 220 are configured as a first cell type (e.g., TLCs).

In some examples, a set of flags may be used to reflect which regions of the lending and borrowing partitions constitute the borrowed portion 260 and helping portion 265 associated with the borrowing state. For example, each of a set of borrow flags 240 may reflect a respective region (e.g., superblock) of the borrowing partition 220 or the lending partition 225. The borrow flags 240 that are set may reflect the regions of the lending and borrowing partitions that are being used as borrowed and helping portions. For example, in the example shown in FIG. 2, the borrow flags 240 corresponding to superblocks 6, 7, and 8 are set, signifying that each of superblocks 6, 7, and 8 is a region of the borrowed portion 260 or the helping portion 265. Since blocks 7 and 8 are in the lending partition 225, their corresponding set flags indicate that those blocks constitute the borrowed portion 260. Since block 6 is in the borrowing partition 220, its set flag indicates that the block constitutes the helping portion 265.

In some examples, the borrow flags 240 may be used in conjunction with the first flag 230. In that case, the borrow flags 240 may indicate, during both the borrowing state and the non-borrowing state, which regions of the partitions are to be used as the borrowed or helping portions. As such, when used in conjunction with the first flag 230, borrow flags 240 corresponding to the borrowed or helping portion may remain set during the borrowing state and the non-borrowing state.

In other examples, the borrow flags 240 may be used instead of the first flag 230. In that case, the borrow flags 240 may be clear in the non-borrowing state (when borrowing is not occurring). That is, when no borrowing is occurring, all of the borrow flags 240 may be clear.

In some examples, a set of flags may be used to reflect which regions associated with the borrowed and helping portions contain valid data associated with the borrowing state. For example, each of a set of valid data flags 250 may reflect a respective region (e.g., superblock) of the borrowed or helping portion that has valid data stored thereon associated with the borrowing state. The valid data flags 250 that are set may reflect the regions of the borrowed and helping portions that have valid data thereon. For example, in the example shown in FIG. 2, the valid data flags 250 corresponding to superblocks 6 and 7 are set, signifying that superblocks 6 and 7 have valid data thereon associated with the borrowed state. In some examples, the valid data flags may correspond to valid data counters that represent the number of valid units (e.g., associated with an LBA). For example, a value of zero may indicate no valid data and other values may represent the number of blocks containing valid data.

The valid data flags may be cleared (e.g., by the controller) when the valid data is moved to another portion of the borrowing partition 220 (e.g., during a garbage collection activity). Because this movement of data may not occur until the borrowed portion 260 is reassigned back to the original (lending) partition 225, valid data may remain in the borrowed and helping portions after the manufacturing program has been completed. To reflect this, the valid data flags 250 may remain set. Once the valid data is moved to the borrowing partition 220, the respective valid data flag 250 may be cleared (e.g., by the controller) and the portion may be used by its original partition. For a helping portion 265, reconfiguring of the memory cells of the helping portion (e.g., from SLCs to TLCs) may not be performed until the respective valid data flag is clear. Other flags may also be used.

In some examples, the borrow flags 240 and/or the valid data flags 250 may be stored in one or more registers. For example, bits of a borrow block register 245 may represent respective borrow flags 240 and bits of a valid data register 255 may represent respective valid data flags 250. A first logic value (e.g., a logic “1” or “0”) in a bit may indicate that the respective flag is set, and a second logic value (e.g., logic value “0” or “1”) in a bit may indicate that the respective flag is clear. For example, in the example shown in FIG. 2, a logic value “1” represents a set value and the bits of the borrow block register 245 match the respective borrow flags 240 and the bits of the valid data register 255 match the respective valid data flags 250.

An example of a method of operation is now given with respect to FIG. 2. During manufacturing, a memory system 200 may be configured to include a plurality of partitions having different regions of memory. For example, the memory array may be configured (e.g., by a controller) to include a normal partition 220 having a first set of superblocks (e.g., superblocks 1-6) and an enhanced memory (EM) partition 225 having a second set of superblocks (e.g., superblocks 7-9). The first set of superblocks may include a first subset (e.g., superblocks 1-3) configured as SLCs, and a second subset (e.g., superblocks 4-6) configured as TLCs. The second set of superblocks (e.g., superblocks 7-9) may be configured as SLCs. In some examples, the partitions may include different sets of operating parameters.

After the memory system has been configured into normal and EM partitions 220 and 225, a borrowing state may be initialized for borrowing a portion 260 of the EM partition 225 for use by the normal partition 220. The borrowing state may be initialized, e.g., as part of a manufacturing process. By borrowing a portion of the EM partition, a larger portion of the normal partition may be used to store information during the manufacturing stage, leading to shorter programming times. For example, a first flag 230 may be set (e.g., by the controller) to indicate the borrowing operating state for use during setting up of system 200 by a manufacturer. During the borrowing state, the borrowed portion 260 of the lending partition 225 may be assigned to the borrowing partition 220 and memory cells of the helping portion 265 of the borrowing partition may be reconfigured. In the depicted example, the normal partition 220 and the EM partition 225 may correspond to the borrowing and lending partitions, respectively.

The borrowed portion 260 may be determined by borrow block flags 240, which may be set (e.g., by the controller) before or after setting the first flag 230. For example, in the depicted example, superblocks 7 and 8 of the EM partition 225 may correspond to the borrowed portion 260, and superblock 6 of the normal partition 220 may correspond to the helping portion 265, as reflected by the set of borrow block flags 240. Thus, during the borrowing state, superblocks 7 and 8 may be assigned to the normal partition 220 and memory cells of superblock 6 may be reconfigured as SLCs.

While in the borrowing state, the borrowed portion 260 may be treated as if it belongs to the borrowing partition. For example, during a manufacturing process, superblocks 7 and 8 may be used by the normal partition 220 as if they had been configured as originally belonging of the normal partition 220. That is, data may be stored and read from superblocks 7 and 8 during memory access operations (e.g., read, write, etc.) associated with the normal partition 220. In some examples, the memory cells of the borrowed portion 260 may be configured as SLCs and used as write boosters during the borrowing state. Using more write boosters may decrease a quantity of time it takes for completing operations, such as store information during the manufacturing stage. Alternatively, to keep the number of superblocks associated with borrowing partition 220 constant, and avoid reshaping the corresponding data structures, the borrowed superblocks might be associated with the “helping superblock” 265.

The memory system may remain in the borrowing state until an event occurs to trigger its end, which may, e.g., be associated with an end of a manufacturing process. In some examples, the event may include: i) an elapsing of a threshold quantity of time, e.g., from the beginning of the start of the borrowing state, ii) an ending of one or more processes, iii) a beginning of one or more processes, or a combination thereof. Other changing events may also be used. In one example, the changing event may be a thermal event, such as applying heat to the memory system to solder components together.

In response to the event, the borrowing state may end and the non-borrowing state may be initiated. After the borrowing state has ended, the borrowed portion 260 may be returned (assigned) back to the lending partition (e.g., by the controller) and the first flag 230 may be cleared. For example, after experiencing a thermal event, superblocks 7 and 8 may be reassigned from the normal partition 220 back to the EM partition 225 and the first flag 230 may be cleared (e.g., by the controller). As discussed herein, until the borrowing state ends, one or more regions of the borrowed portion 260 and/or helping portion 265 may still contain valid data associated with the borrowing state, as reflected by the valid data flags 250.

A garbage collection operation may be performed on one or more of these regions to move the valid data to other regions of the borrowing (e.g., normal) partition before the borrowing state is cleared. For example, a garbage collection operation may be performed to move valid data from a region of superblock 6, 7, or 8 to a region of any of superblocks 1-5. Once all of the valid data of a borrowed region of the borrowed portion 260 is moved to another region of the borrowing partition 220 (e.g., the normal partition), the borrowed region may be used by the lending partition 225 (e.g., the EM partition), as normal. Once valid data of a region of the helping portion 265 is moved to another region of the borrowing (normal) partition 220, the memory cells of the region may be reconfigured back to their original memory cell type (e.g., from SLCs to TLCs) (e.g., by the controller).

During the non-borrowing state, each partition may be used by the controller, separately from the other partitions, as is known in the art. For example, in the normal operating state, superblocks 1-6 of the normal partition 220 may be used, e.g., to store applications and their static data, such as navigation applications and corresponding maps, etc., and superblocks 7-9 of the EM partition 225 may be used, e.g., to write temporary data such as logs, black box data, or similar. Also during the non-borrowing state, garbage collection operations may be performed on each partition in the normal manner. For example, valid data may be moved from regions of superblocks 1-6 to regions of superblocks 1-6 and valid data may be moved from regions of superblocks 7-9 to regions of superblocks 7-9. In some examples, during the non-borrowing state the valid data flags 250 may be used to identify the regions (e.g., superblocks) which contain valid data to be moved.

In general, during the non-borrowing state and the borrowing state, each partition may be used separately from the other partitions, except that during the borrowing state, the borrowed portion of the lending partition may be treated as if it belongs to the borrowing partition.

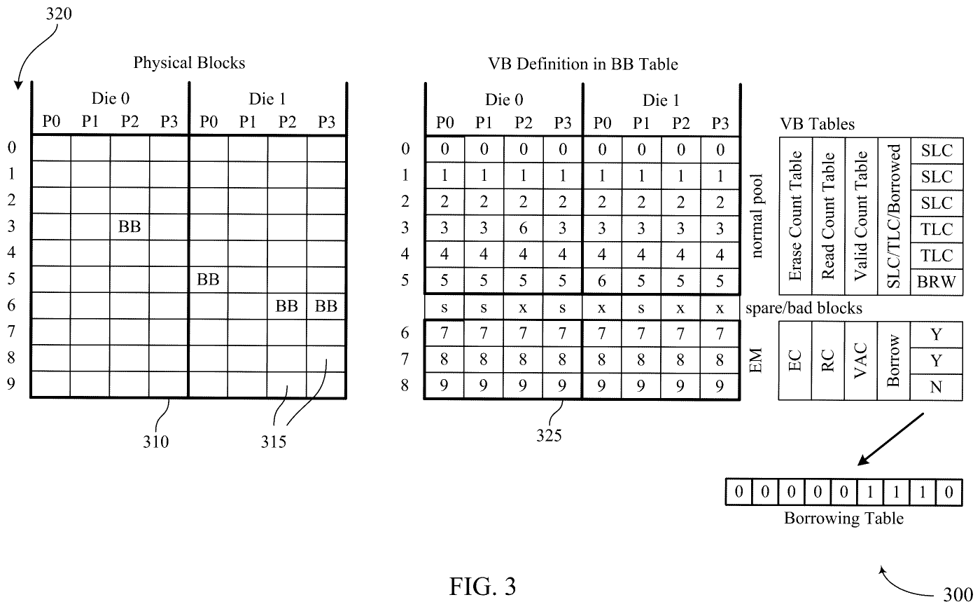

FIG. 3 shows an example of a memory system 300 that supports superblock pool expansion for enhanced manufacturing in accordance with examples as disclosed herein. The memory system 300 may be an example of a memory system 110 or 200 as described with reference to FIGS. 1 and 2, or aspects thereof. The memory system 300 may include one or more arrays of memory cells separated into blocks 315 and/or superblocks 320. The blocks 315 and superblocks 320 may be an example of the blocks 170 and virtual blocks 180 as described with reference to FIG. 1.

In some examples, a subset of regions of memory may be held back and used as replacements for regions that may experience errors. A first table 310 represents physical blocks associated with two dies. Each cell of the table represents a physical block 315 of a plane of the die. All of the blocks in a row of the table may form a superblock 320. For example, the system represented by the first table 310 may have 10 superblocks 320, labeled 0-9. A second table 325 shows a mapping of the physical blocks 315 that may be used when the physical blocks are addressed (e.g., instead of the physical blocks that are addressed). For example, when the physical block associated with superblock 0 and plane P0 of die 0 is addressed, the second table 325 indicates that the physical block associated with superblock 0 and plane P0 of die 0 may be used. As reflected by the second table 325, most (or all) of the blocks may be mapped to the same physical blocks that are addressed.

In some examples, the addressable amount of memory may be less than the total amount of memory in the system so that some of the memory may be used as replacements for bad memory. For example, as shown in the second table 325, blocks associated with physical superblocks 0-8 may be generally mapped to blocks associated with physical superblocks 0-5 and 7-9, respectively, such that one physical superblock (e.g., superblock 6) may be unmapped. By doing so, physical blocks associated with superblock 6 may be used to substitute for bad blocks.

For example, as shown in the first table 310, a few physical blocks (denoted “BB”) may be exhibiting errors and therefore considered to be bad blocks. To mitigate for the faulty memory, those physical blocks may be remapped to blocks in unused superblock 6, as reflected in the second table 325. If any block in superblock 6 is considered to be a bad block (as in the first table 310), that block may not be remapped since it is already in superblock 6 and thus unused.

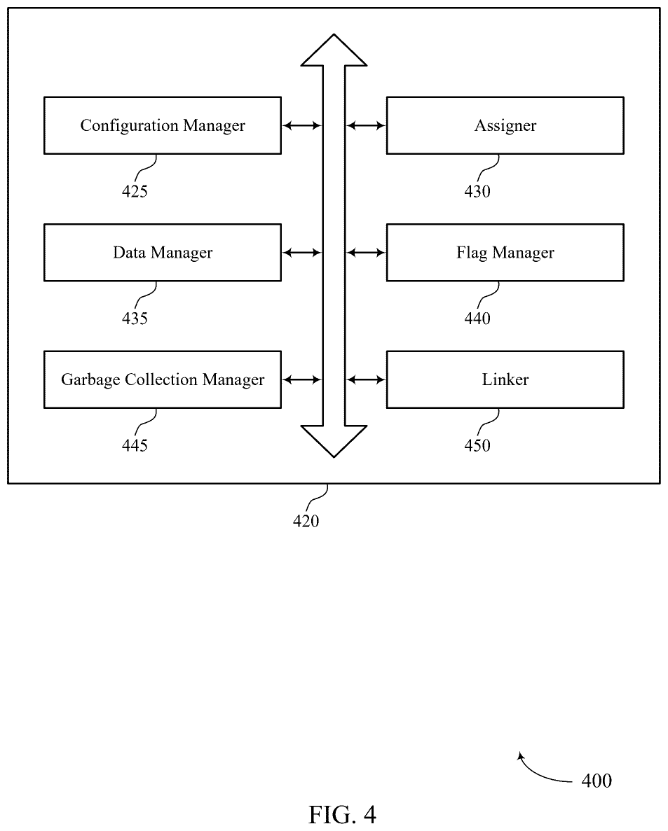

FIG. 4 shows a block diagram 400 of a memory system 420 that supports superblock pool expansion for enhanced manufacturing in accordance with examples as disclosed herein. The memory system 420 may be an example of aspects of a memory system as described with reference to FIGS. 1 through 3. The memory system 420, or various components thereof, may be an example of means for performing various aspects of superblock pool expansion for enhanced manufacturing as described herein. For example, the memory system 420 may include a configuration manager 425, an assigner 430, a data manager 435, a flag manager 440, a garbage collection manager 445, a linker 450, or any combination thereof. Each of these components, or components of subcomponents thereof (e.g., one or more processors, one or more memories), may communicate, directly or indirectly, with one another (e.g., via one or more buses).

The configuration manager 425 may be configured as or otherwise support a means for configuring the memory system to include a first partition and a second partition, the first partition configured with a first set of operating parameters and the second partition configured with a second set of operating parameters. The assigner 430 may be configured as or otherwise support a means for assigning a first portion of the second partition to the first partition after configuring the first partition and the second partition. The data manager 435 may be configured as or otherwise support a means for storing data to the first partition after assigning the first portion to the first partition and as part of a manufacturing process. In some examples, the assigner 430 may be configured as or otherwise support a means for assigning the first portion to the second partition after experiencing an event of the manufacturing process.

In some examples, the first partition and the second partition have separate pools of blocks for different usage modes.

In some examples, the first partition includes blocks having memory cells configured as single-level cells and blocks having memory cells configured as triple-level cells. In some examples, the second partition includes blocks having memory cells configured as single-level cells.

In some examples, the event includes an elapsing of a period of time, a beginning of one or more processes, completion of one or more processes, or a combination thereof.

In some examples, the flag manager 440 may be configured as or otherwise support a means for setting a flag that indicates the first portion of the second partition is assigned to the first partition after assigning the first portion to the first partition, where storing the data is based at least in part on setting the flag.

In some examples, the first portion includes a plurality of superblocks, and the flag includes a plurality of flags, where each flag of the plurality of flags is associated with a respective superblock of the plurality of superblocks.

In some examples, the flag manager 440 may be configured as or otherwise support a means for clearing the flag that corresponds to the first portion after assigning the first portion to the first partition.

In some examples, the garbage collection manager 445 may be configured as or otherwise support a means for performing a garbage collection operation on the first portion after assigning the first portion back to the second partition. In some examples, the data manager 435 may be configured as or otherwise support a means for transferring valid data stored in the first portion to the first partition based at least in part on performing the garbage collection operation.

In some examples, the configuration manager 425 may be configured as or otherwise support a means for configuring memory cells of the first portion of the second partition as single-level cells based at least in part on assigning the first portion to the first partition. In some examples, the configuration manager 425 may be configured as or otherwise support a means for configuring memory cells of a second portion of the first partition as single-level cells based at least in part on assigning the first portion to the first partition.

In some examples, the linker 450 may be configured as or otherwise support a means for linking superblocks of the first portion and the second portion to form three superblocks of single-level cells based at least in part on configuring the first portion. A device may configure the memory system to include a first partition and a second partition, the first partition configured with a first set of operating parameters and the second partition configured with a second set of operating parameters. A device may assign a first portion of the second partition to the first partition after configuring the first partition and the second partition. A device may store data to the first partition after assigning the first portion to the first partition and as part of a manufacturing process. A device may assign the first portion to the second partition after experiencing an event of the manufacturing process. In some examples, the assigner 430 may be configured as or otherwise support a means for assigning the linked superblocks to data structure configured to track a single superblock of triple-level cells for the first partition, where storing the data to the first portion is based at least in part on assigning the linked superblocks to the data structure.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

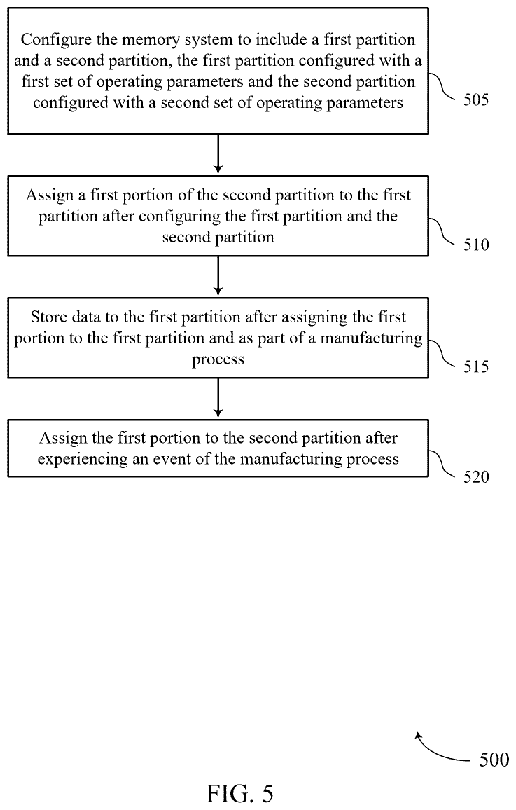

FIG. 5 shows a flowchart illustrating a method 500 that supports superblock pool expansion for enhanced manufacturing in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include configuring the memory system to include a first partition and a second partition, the first partition configured with a first set of operating parameters and the second partition configured with a second set of operating parameters. In some examples, aspects of the operations of 505 may be performed by a configuration manager 425 as described with reference to FIG. 4.

At 510, the method may include assigning a first portion of the second partition to the first partition after configuring the first partition and the second partition. In some examples, aspects of the operations of 510 may be performed by an assigner 430 as described with reference to FIG. 4.

At 515, the method may include storing data to the first partition after assigning the first portion to the first partition and as part of a manufacturing process. In some examples, aspects of the operations of 515 may be performed by a data manager 435 as described with reference to FIG. 4.

At 520, the method may include assigning the first portion to the second partition after experiencing an event of the manufacturing process. In some examples, aspects of the operations of 520 may be performed by an assigner 430 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for configuring the memory system to include a first partition and a second partition, the first partition configured with a first set of operating parameters and the second partition configured with a second set of operating parameters; assigning a first portion of the second partition to the first partition after configuring the first partition and the second partition; storing data to the first partition after assigning the first portion to the first partition and as part of a manufacturing process; and assigning the first portion to the second partition after experiencing an event of the manufacturing process.
Aspect 2: The method, apparatus, or non-transitory computer-readable medium of aspect 1, where the first partition and the second partition have separate pools of blocks for different usage modes.
Aspect 3: The method, apparatus, or non-transitory computer-readable medium of any of aspects 1 through 2, where the first partition includes blocks having memory cells configured as single-level cells and blocks having memory cells configured as triple-level cells and the second partition includes blocks having memory cells configured as single-level cells.
Aspect 4: The method, apparatus, or non-transitory computer-readable medium of any of aspects 1 through 3, where the event includes an elapsing of a period of time, a beginning of one or more processes, completion of one or more processes, or a combination thereof.
Aspect 5: The method, apparatus, or non-transitory computer-readable medium of any of aspects 1 through 4, further including operations, features, circuitry, logic, means, or instructions, or any combination thereof for setting a flag that indicates the first portion of the second partition is assigned to the first partition after assigning the first portion to the first partition, where storing the data is based at least in part on setting the flag.
Aspect 6: The method, apparatus, or non-transitory computer-readable medium of aspect 5, where the first portion includes a plurality of superblocks, and the flag includes a plurality of flags, where each flag of the plurality of flags is associated with a respective superblock of the plurality of superblocks.
Aspect 7: The method, apparatus, or non-transitory computer-readable medium of any of aspects 5 through 6, further including operations, features, circuitry, logic, means, or instructions, or any combination thereof for clearing the flag that corresponds to the first portion after assigning the first portion to the first partition.
Aspect 8: The method, apparatus, or non-transitory computer-readable medium of any of aspects 1 through 7, further including operations, features, circuitry, logic, means, or instructions, or any combination thereof for performing a garbage collection operation on the first portion after assigning the first portion back to the second partition and transferring valid data stored in the first portion to the first partition based at least in part on performing the garbage collection operation.
Aspect 9: The method, apparatus, or non-transitory computer-readable medium of any of aspects 1 through 8, further including operations, features, circuitry, logic, means, or instructions, or any combination thereof for configuring memory cells of the first portion of the second partition as single-level cells based at least in part on assigning the first portion to the first partition and configuring memory cells of a second portion of the first partition as single-level cells based at least in part on assigning the first portion to the first partition.
Aspect 10: The method, apparatus, or non-transitory computer-readable medium of aspect 9, further including operations, features, circuitry, logic, means, or instructions, or any combination thereof for linking superblocks of the first portion and the second portion to form three superblocks of single-level cells based at least in part on configuring the first portion and the second portion and assigning the linked superblocks to data structure configured to track a single superblock of triple-level cells for the first partition, where storing the data to the first portion is based at least in part on assigning the linked superblocks to the data structure.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memories storing processor-executable code; and
one or more processors coupled with the one or more memories and individually or collectively operable to execute the code to cause the memory system to:
configure the memory system to include a first partition and a second partition, the first partition configured with a first set of operating parameters and the second partition configured with a second set of operating parameters;
assign a first portion of the second partition to the first partition after configuring the first partition and the second partition;
store data to the first partition after assigning the first portion to the first partition and as part of a manufacturing process; and
assign the first portion to the second partition after experiencing an event of the manufacturing process.

2. The memory system of claim 1, wherein:
the first partition and the second partition have separate pools of blocks for different usage modes.

3. The memory system of claim 1, wherein:
the first partition comprises blocks having memory cells configured as single-level cells and blocks having memory cells configured as triple-level cells, and
the second partition comprises blocks having memory cells configured as single-level cells.

4. The memory system of claim 1, wherein the event comprises an elapsing of a period of time, a beginning of one or more processes, completion of one or more processes, or a combination thereof.

5. The memory system of claim 1, wherein the one or more processors are individually or collectively further operable to execute the code to cause the memory system to:
set a flag that indicates the first portion of the second partition is assigned to the first partition after assigning the first portion to the first partition, wherein storing the data is based at least in part on setting the flag.

6. The memory system of claim 5, wherein the first portion comprises a plurality of superblocks, and the flag comprises a plurality of flags, where each flag of the plurality of flags is associated with a respective superblock of the plurality of superblocks.

7. The memory system of claim 5, wherein the one or more processors are individually or collectively further operable to execute the code to cause the memory system to:
clear the flag that corresponds to the first portion after assigning the first portion to the first partition.

8. The memory system of claim 1, wherein the one or more processors are individually or collectively further operable to execute the code to cause the memory system to:
perform a garbage collection operation on the first portion before assigning the first portion back to the second partition; and
transfer valid data stored in the first portion to the first partition based at least in part on performing the garbage collection operation.

9. The memory system of claim 1, wherein the one or more processors are individually or collectively further operable to execute the code to cause the memory system to:
configure memory cells of the first portion of the second partition as single-level cells based at least in part on assigning the first portion to the first partition; and
configure memory cells of a second portion of the first partition as single-level cells based at least in part on assigning the first portion to the first partition.

10. The memory system of claim 9, wherein the one or more processors are individually or collectively further operable to execute the code to cause the memory system to:
link superblocks of the first portion and the second portion to form three superblocks of single-level cells based at least in part on configuring the first portion and the second portion; and
assign the linked superblocks to data structure configured to track a single superblock of triple-level cells for the first partition, wherein storing the data to the first portion is based at least in part on assigning the linked superblocks to the data structure.

11. A non-transitory computer-readable medium storing code, the code comprising instructions executable by one or more processors to:
configure a memory system to include a first partition and a second partition, the first partition configured with a first set of operating parameters and the second partition configured with a second set of operating parameters;
assign a first portion of the second partition to the first partition after configuring the first partition and the second partition;
store data to the first partition after assigning the first portion to the first partition and as part of a manufacturing process; and
assign the first portion to the second partition after experiencing an event of the manufacturing process.

12. The non-transitory computer-readable medium of claim 11, wherein:
the first partition and the second partition have separate pools of blocks for different usage modes.

13. The non-transitory computer-readable medium of claim 11, wherein the instructions are further executable by the one or more processors to:
set a flag that indicates the first portion of the second partition is assigned to the first partition after assigning the first portion to the first partition, wherein storing the data is based at least in part on setting the flag.

14. The non-transitory computer-readable medium of claim 13, wherein the first portion comprises a plurality of superblocks, and the flag comprises a plurality of flags, where each flag of the plurality of flags is associated with a respective superblock of the plurality of superblocks.

15. The non-transitory computer-readable medium of claim 11, wherein the instructions are further executable by the one or more processors to:
configure memory cells of the first portion of the second partition as single-level cells based at least in part on assigning the first portion to the first partition; and
configure memory cells of a second portion of the first partition as single-level cells based at least in part on assigning the first portion to the first partition.

16. The non-transitory computer-readable medium of claim 15, wherein the instructions are further executable by the one or more processors to:
link superblocks of the first portion and the second portion to form three superblocks of single-level cells based at least in part on configuring the first portion and the second portion; and
assign the linked superblocks to data structure configured to track a single superblock of triple-level cells for the first partition, wherein storing the data to the first portion is based at least in part on assigning the linked superblocks to the data structure.

17. A method at a memory system, comprising:
configuring the memory system to include a first partition and a second partition, the first partition configured with a first set of operating parameters and the second partition configured with a second set of operating parameters;
assigning a first portion of the second partition to the first partition after configuring the first partition and the second partition;
storing data to the first partition after assigning the first portion to the first partition and as part of a manufacturing process; and
assigning the first portion to the second partition after experiencing an event of the manufacturing process.

18. The method of claim 17, further comprising:
setting a flag that indicates the first portion of the second partition is assigned to the first partition after assigning the first portion to the first partition, wherein storing the data is based at least in part on setting the flag.

19. The method of claim 17, further comprising:
configuring memory cells of the first portion of the second partition as single-level cells based at least in part on assigning the first portion to the first partition; and
configuring memory cells of a second portion of the first partition as single-level cells based at least in part on assigning the first portion to the first partition.

20. The method of claim 19, further comprising:
linking superblocks of the first portion and the second portion to form three superblocks of single-level cells based at least in part on configuring the first portion and the second portion; and
assigning the linked superblocks to data structure configured to track a single superblock of triple-level cells for the first partition, wherein storing the data to the first portion is based at least in part on assigning the linked superblocks to the data structure.
